(19) United States
(12) Patent Application Publication
(10) Pub. No.: US 2012/0250468 A1
(43) Pub. Date: Oct. 4, 2012

(54) ESCAPEMENT MECHANISM IN PARTICULAR FOR A TIMEPIECE MOVEMENT

(75) Inventors: Kéwin BAS, Villers-Le-Lac (FR); Cyrille CHATEL, La Chenalotte (FR)

(73) Assignee: CARTIER CREATION STUDIO S.A., Geneva (CH)

(21) Appl. No.: 13/437,106

(22) Filed: Apr. 2, 2012

(30) Foreign Application Priority Data
Mar. 31, 2011 (EP) 11002656.4

(51) Int. Cl. G04B 15/00

(52) U.S. Cl. 368/129

(57) ABSTRACT

A timepiece movement includes an escapement mobile connected to a barrel by a going train and a spring balance as well as an escapement mechanism (1) including an impulse lever (8) and at least one regulating member (9). The impulse lever (8) and the regulating member (9), which co-operate with the escapement mobile, are controlled by control members (6.1, 6.2, 7.1) supported on the axle of the balance. Between positions in which they co-operate with the escapement mobile (1) and positions in which they do not co-operate with the escapement mobile, the impulse lever (8) and the regulating member (9) move in two different planes forming an angle therebetween.

The present invention relates to escapement mechanisms for a timepiece movement.

In a movement for a timepiece, the aim of the escapement is to maintain and count the oscillations of the regulating member of said movement, such as for example a spring balance. The escapement receives the energy dispensed by the barrel of the movement for the timepiece and allows the periodic escape of a portion of this energy to return to the regulating member the energy which it loses due to friction. It is important that the escapement disrupts the regulating member to the least extent possible.

However, the mechanical performance of escapements is typically poor since the one which is generally considered to be the best of them all, the Swiss lever escapement, only transmits about 30% of the energy it receives to the regulating member. This is due in particular to the inertia of the parts which are caused to move rapidly, to friction, to impacts and to the necessary presence of lost travel.

The aim of the present invention is to provide a timepiece movement comprising an escapement mechanism in which the inertia of the moving parts in the event of an impulse is very low and in which the vast majority or all of the angular travel of the impulse member is active, thereby removing lost travel. Another aim of the present invention is the provision of a timepiece movement in which the performance of the escapement mechanism is greatly improved, as is the precision of the chronometry of the movement.

The present invention relates to a timepiece movement comprising an escapement mobile connected to a barrel by a going train and a spring balance as well as an escapement mechanism comprising an impulse lever and at least one regulating member, characterised in that the impulse lever and the regulating member are controlled by control members supported by the axle of the balance; in that the impulse lever and the regulating member co-operate with the escapement mobile; and in that the impulse lever and the regulating member move in two planes forming an angle therebetween.

Several particular embodiments of the escapement mechanism for a timepiece movement in accordance with the invention are illustrated schematically and by way of example in the accompanying drawing, in which:

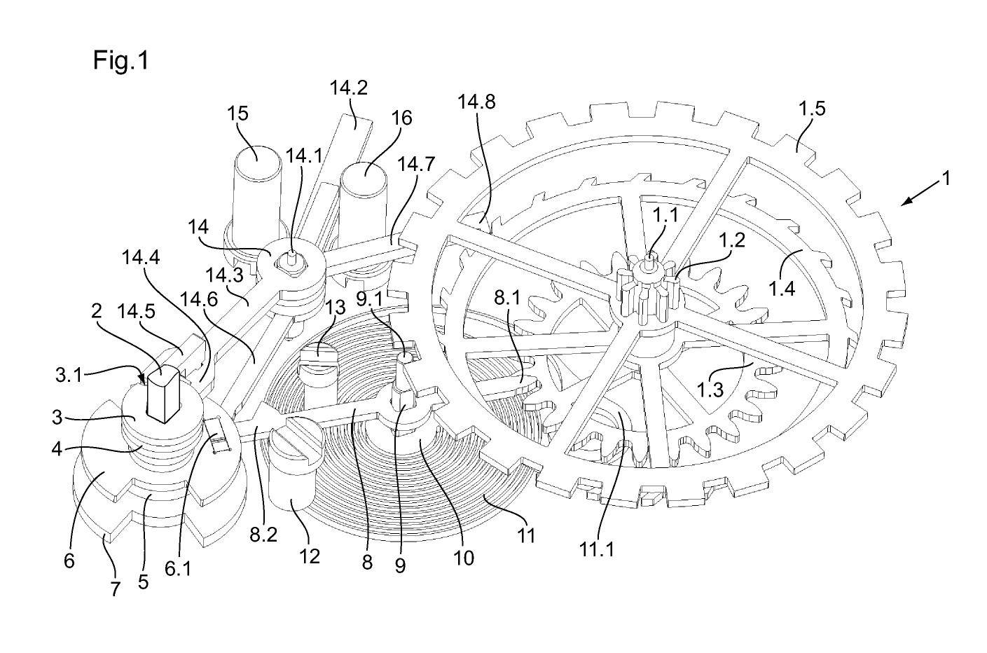

FIG. 1 is an overall perspective view of a first embodiment of an escapement mechanism for a timepiece movement in accordance with the invention,

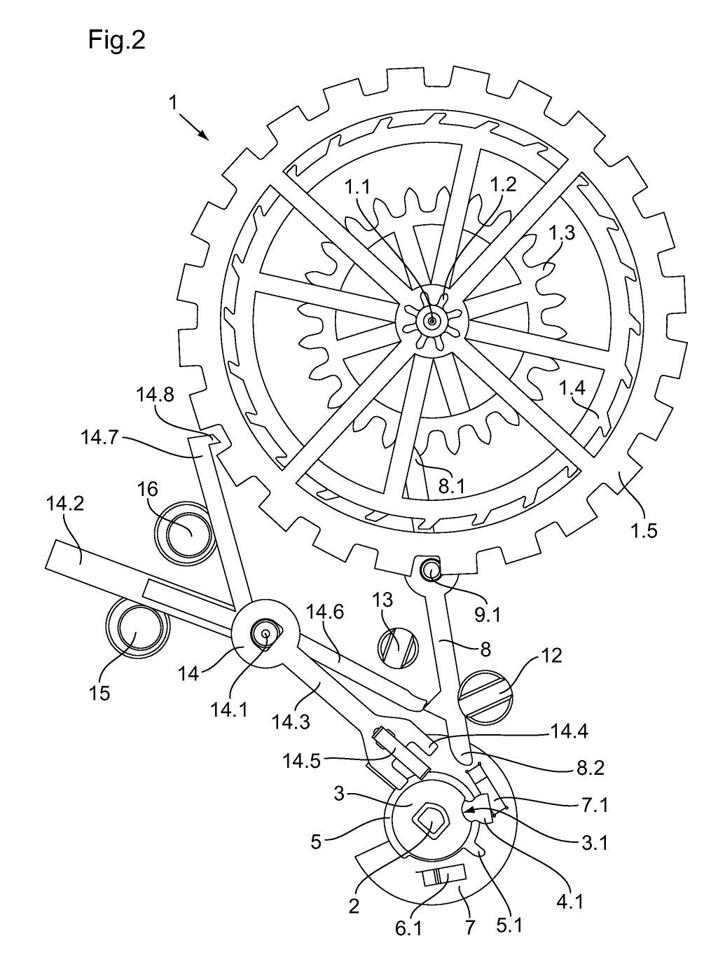

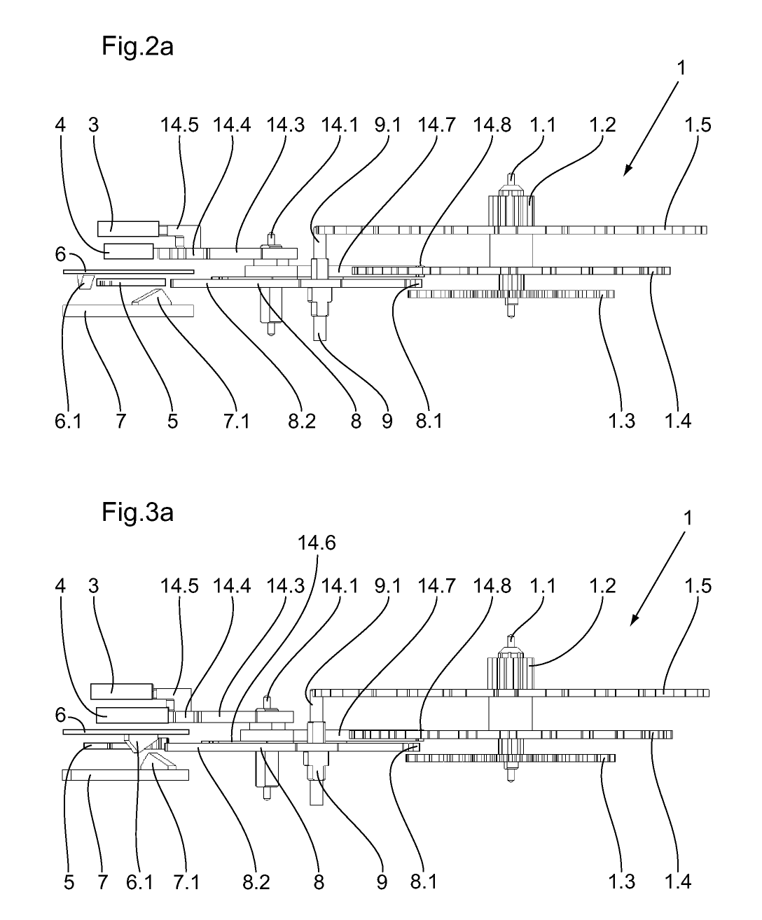

FIGS. 2 and 2a are plan and side views of the mechanism of FIG. 1 in its initial position,

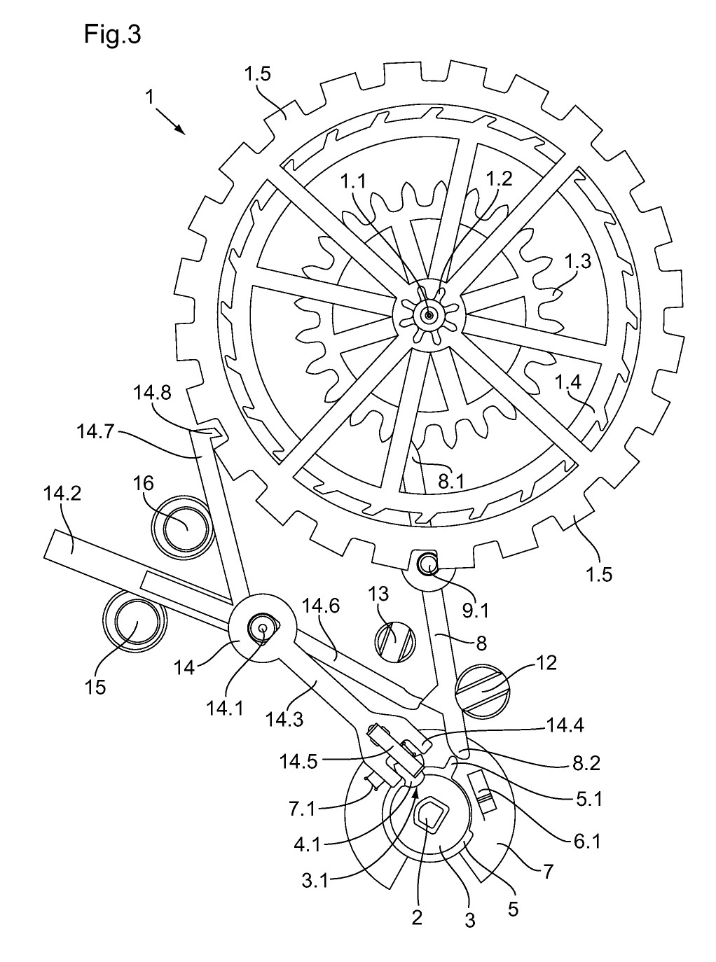

FIGS. 3 and 3a are plan and side views of the mechanism when the impulse lever is released,

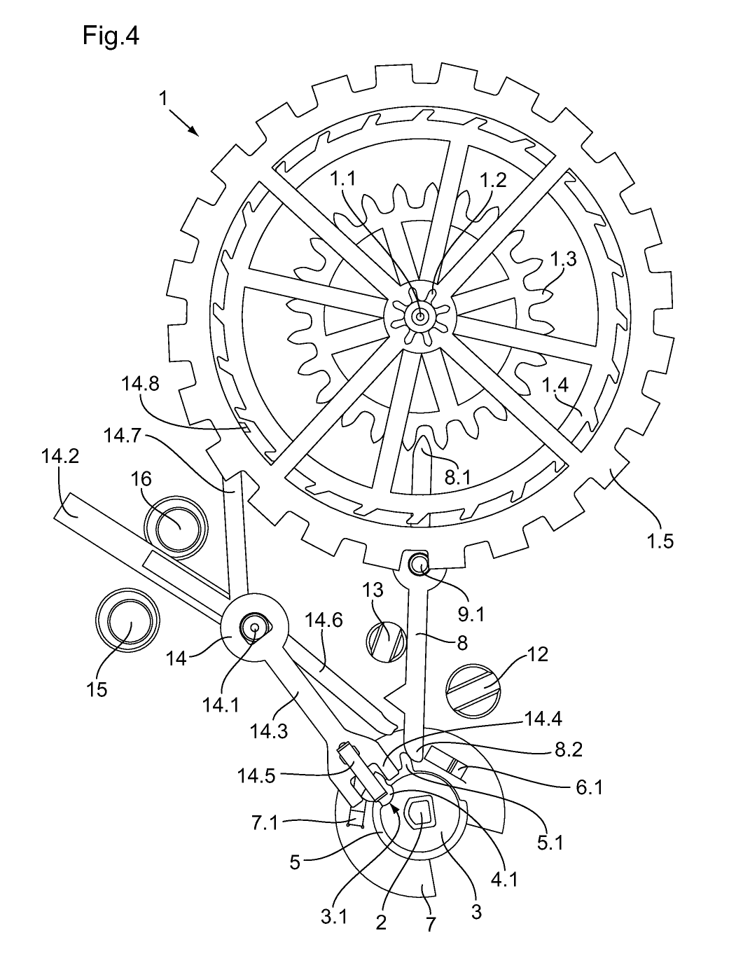

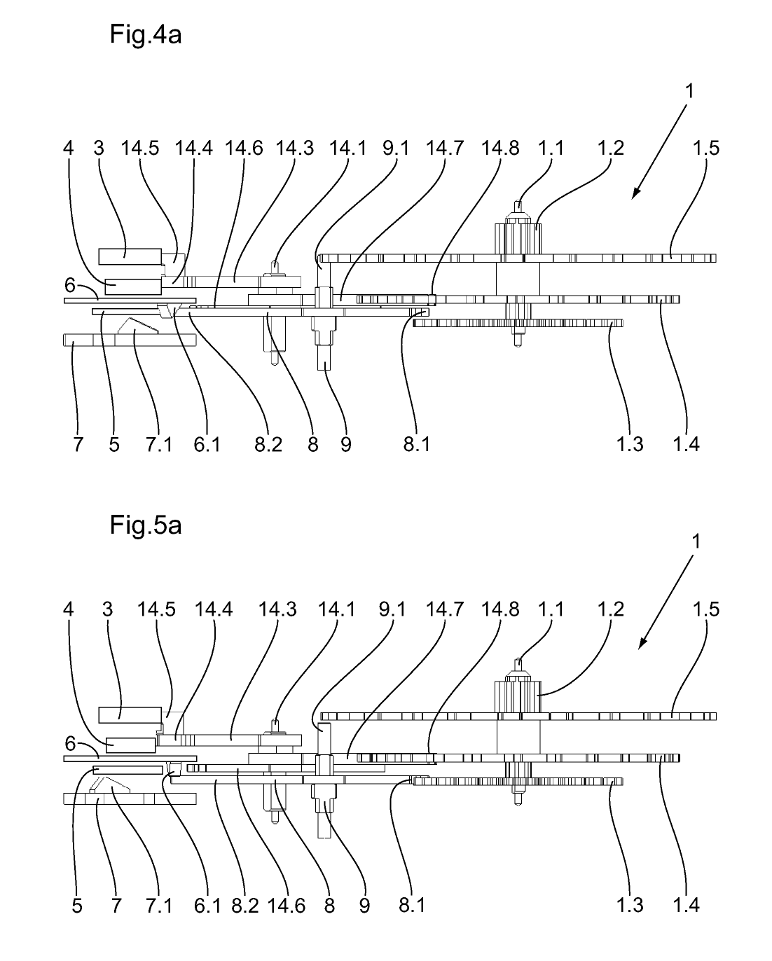

FIGS. 4 and 4a are plan and side views of the mechanism at the end of the rotation of the impulse lever,

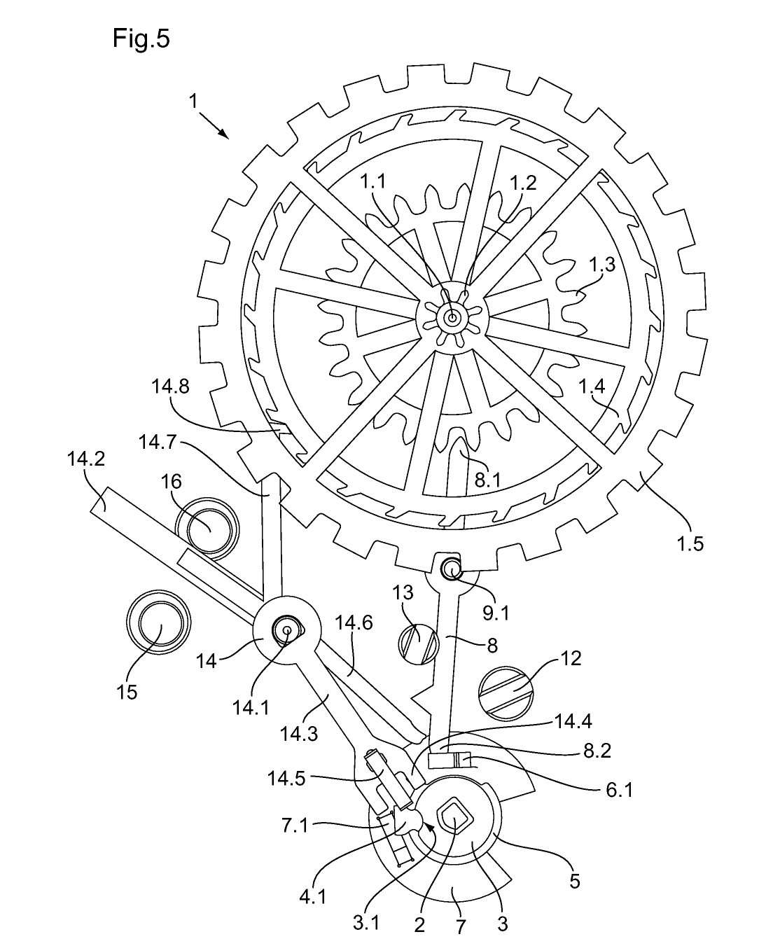

FIGS. 5 and 5a are plan and side views of the mechanism when the impulse lever is engaged with the escapement wheel,

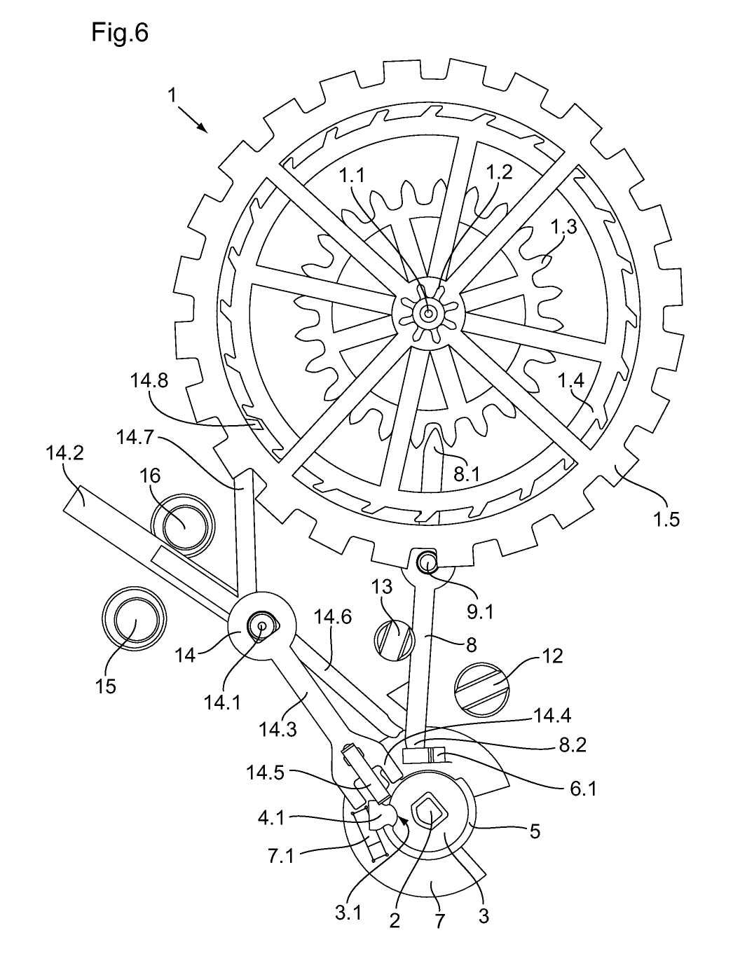

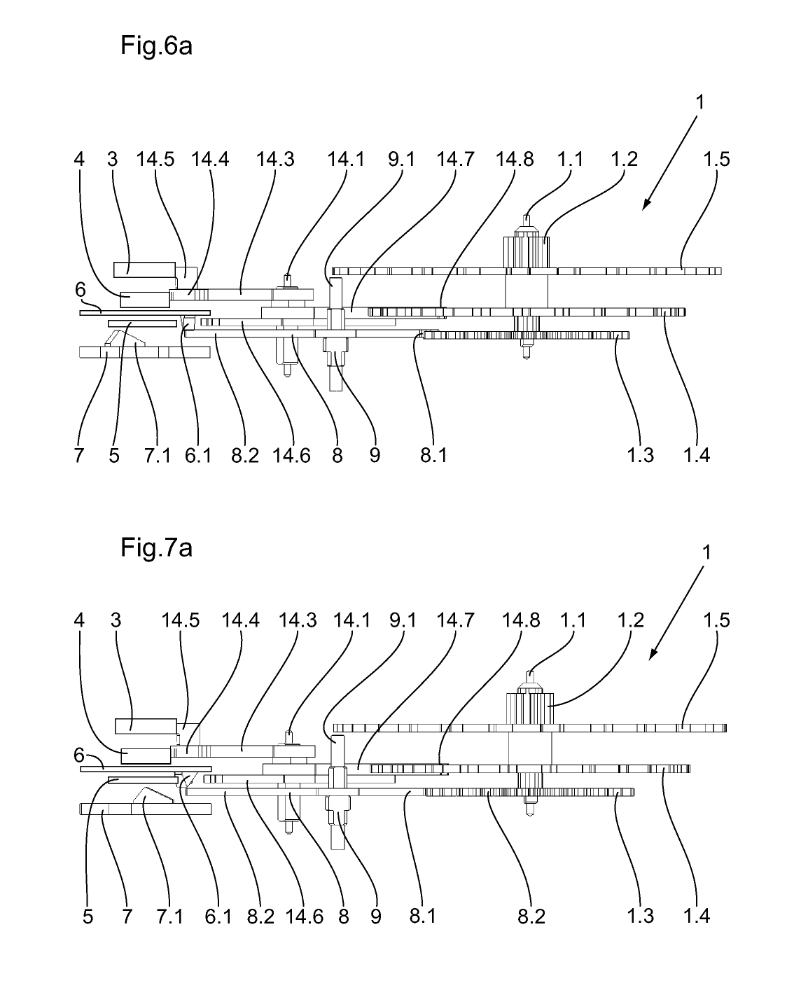

FIGS. 6 and 6a are plan and side views of the mechanism at the end of the first re-winding phase of the impulse lever,

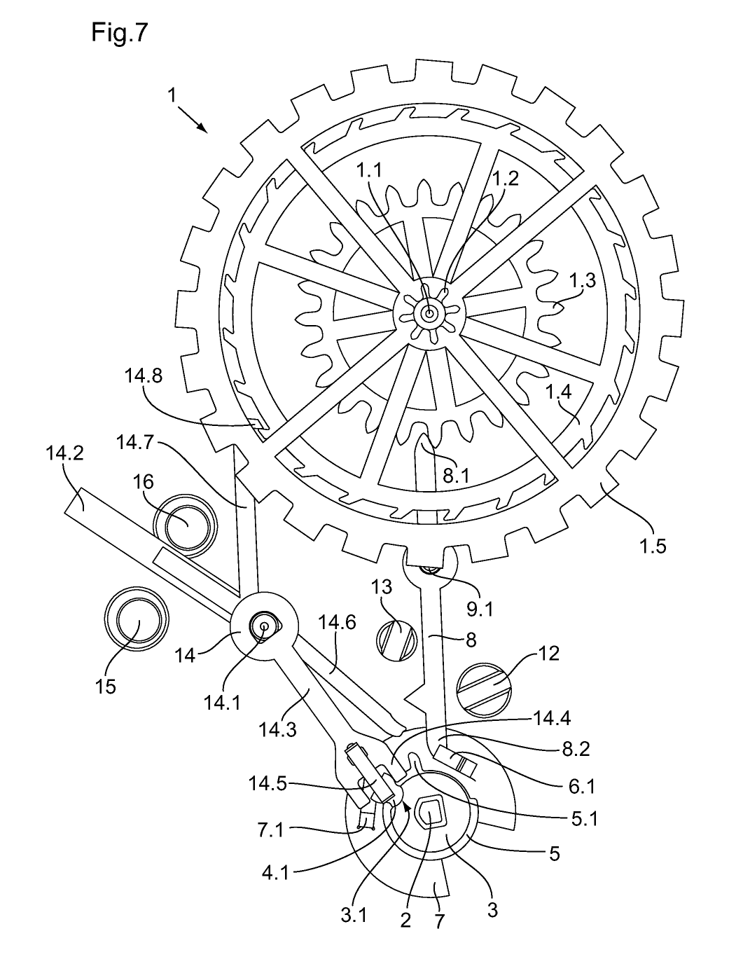

FIGS. 7 and 7a are plan and side views of the mechanism during the second re-winding phase of the impulse lever,

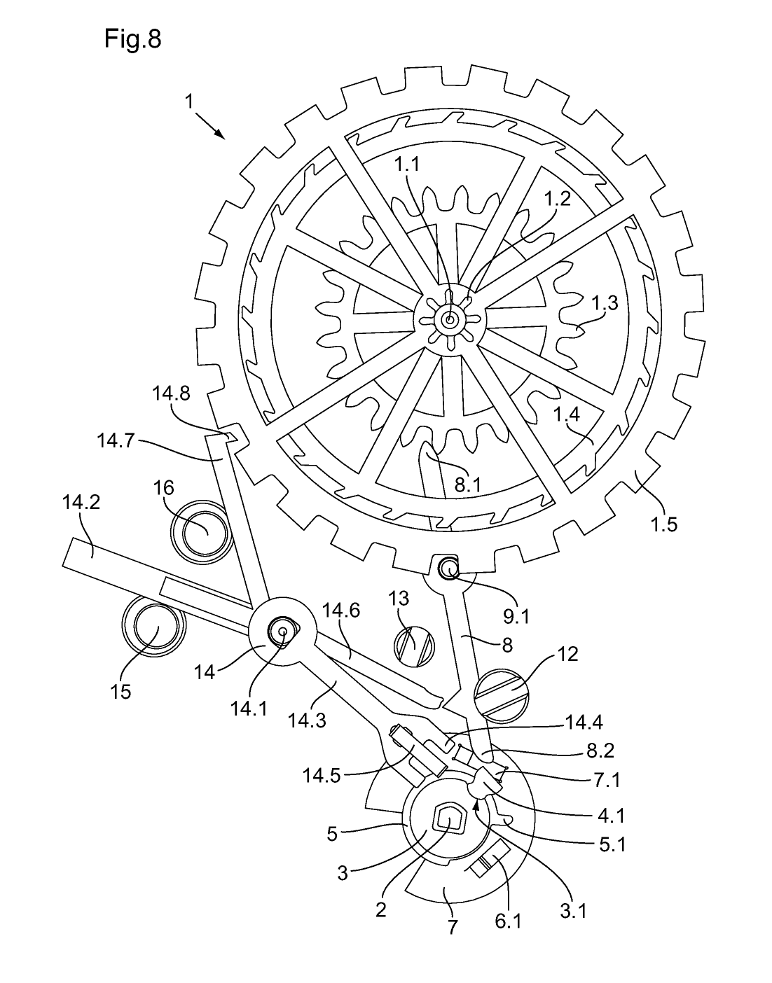

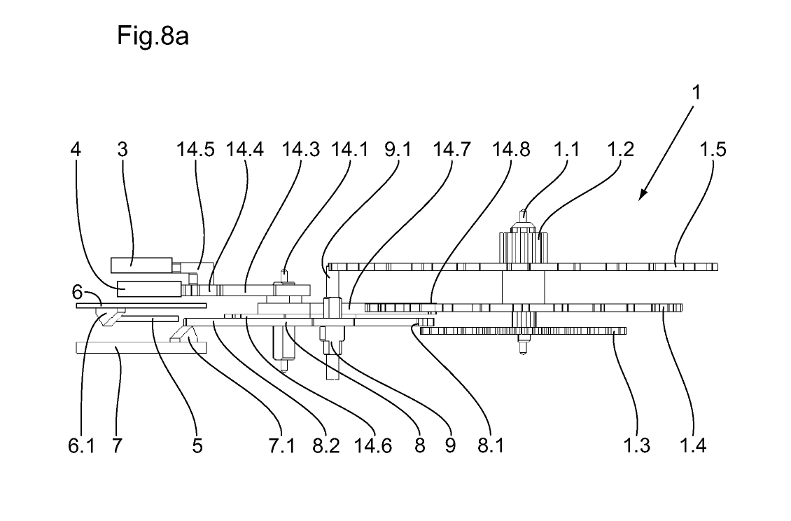

FIGS. 8 and 8a are plan and side views of the mechanism during its return to the initial position,

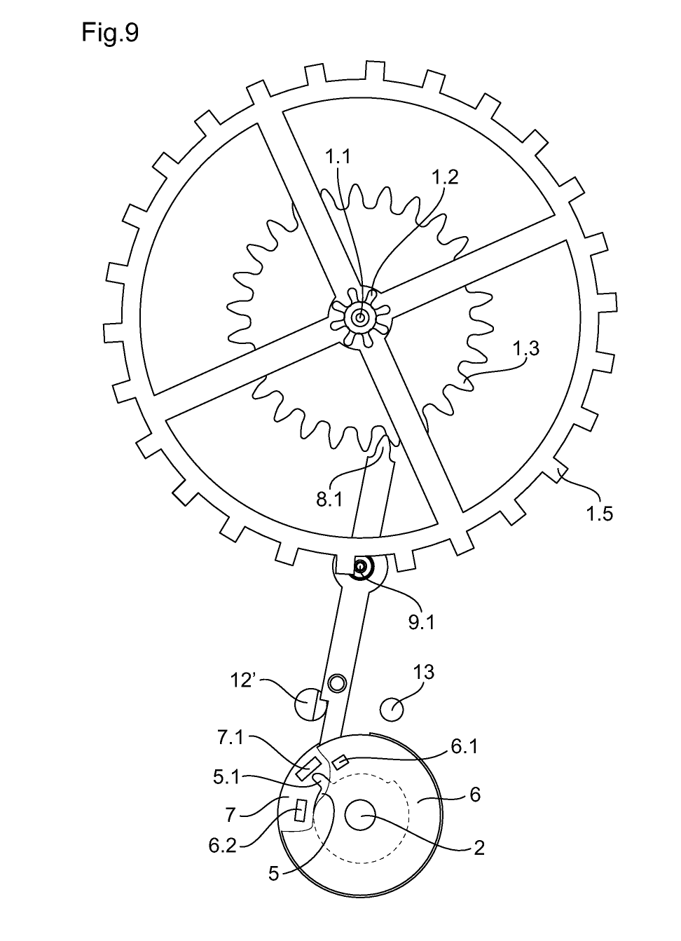

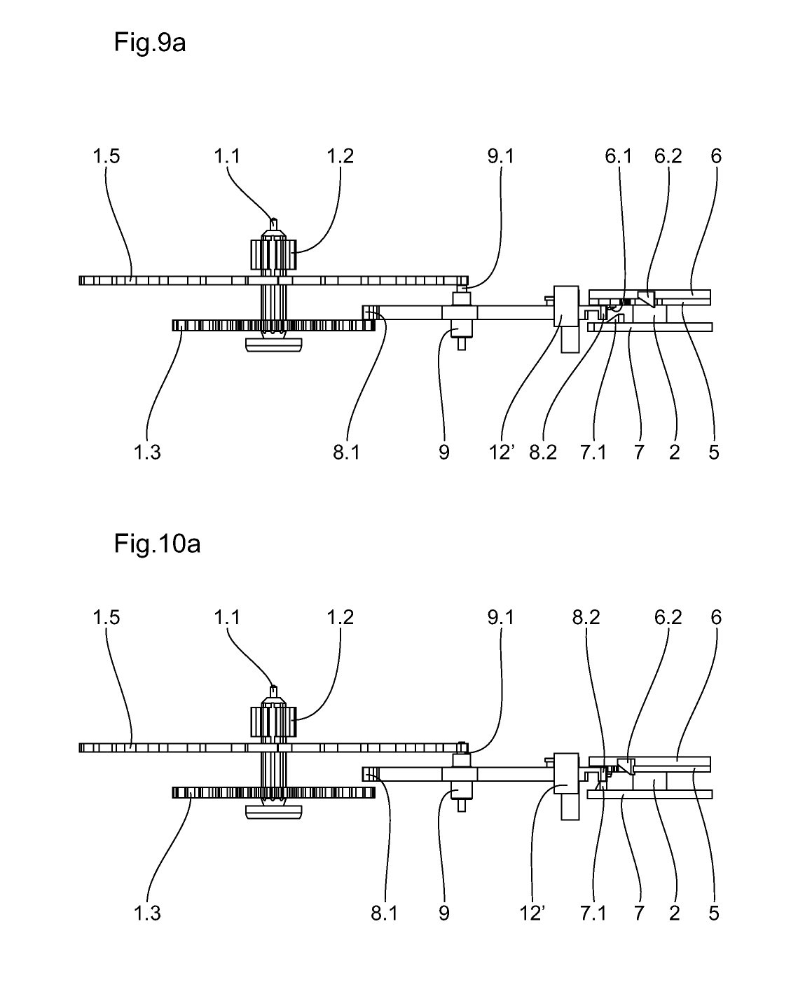

FIGS. 9 and 9a are plan and side views of a second embodiment of an escapement mechanism for a timepiece movement in accordance with the invention in its initial position,

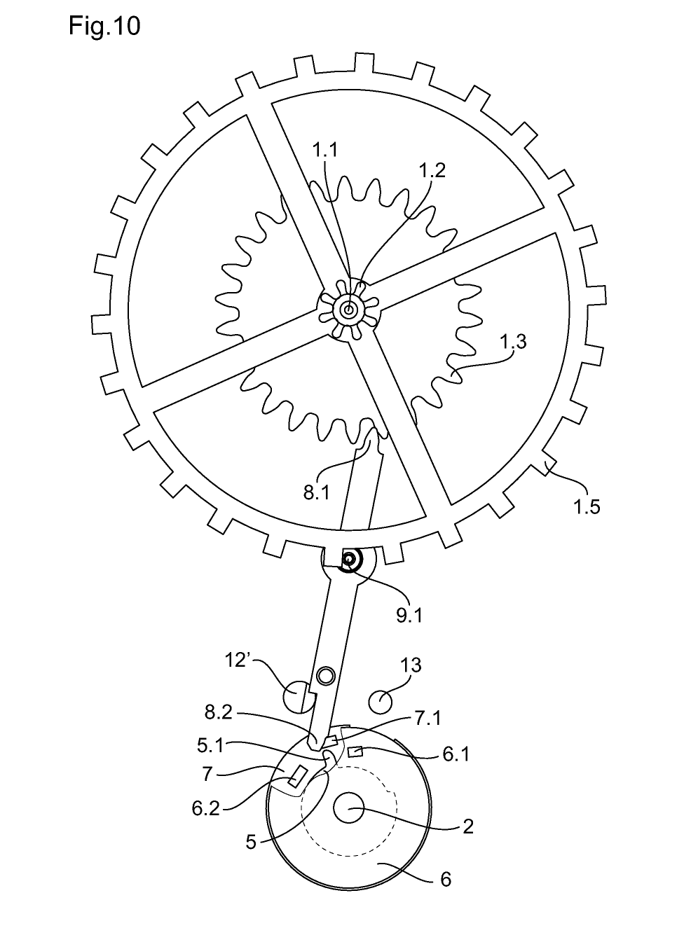

FIGS. 10 and 10a are plan and side views of the mechanism when the impulse lever is released,

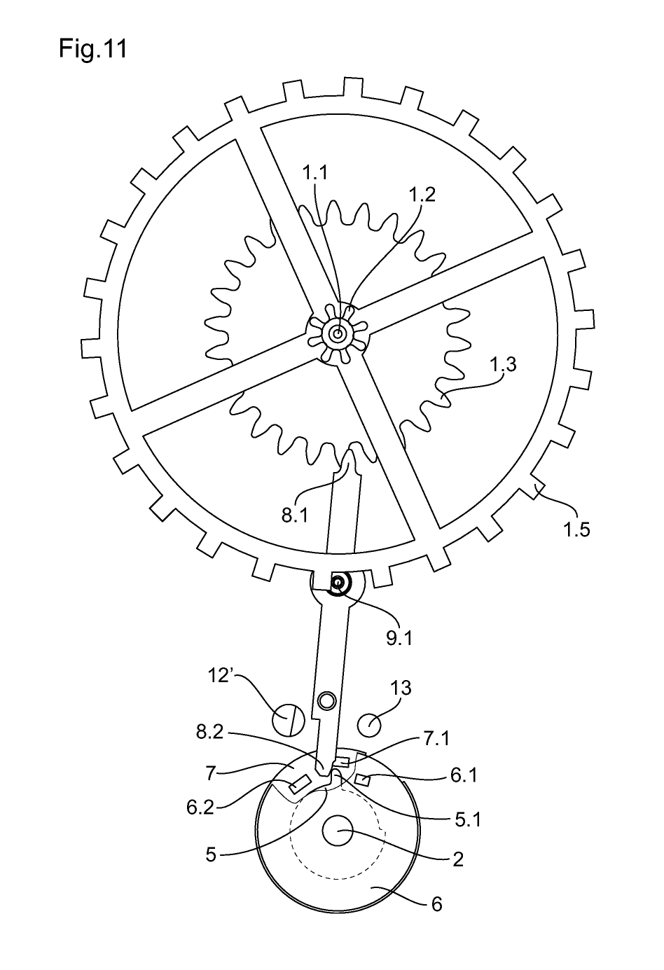

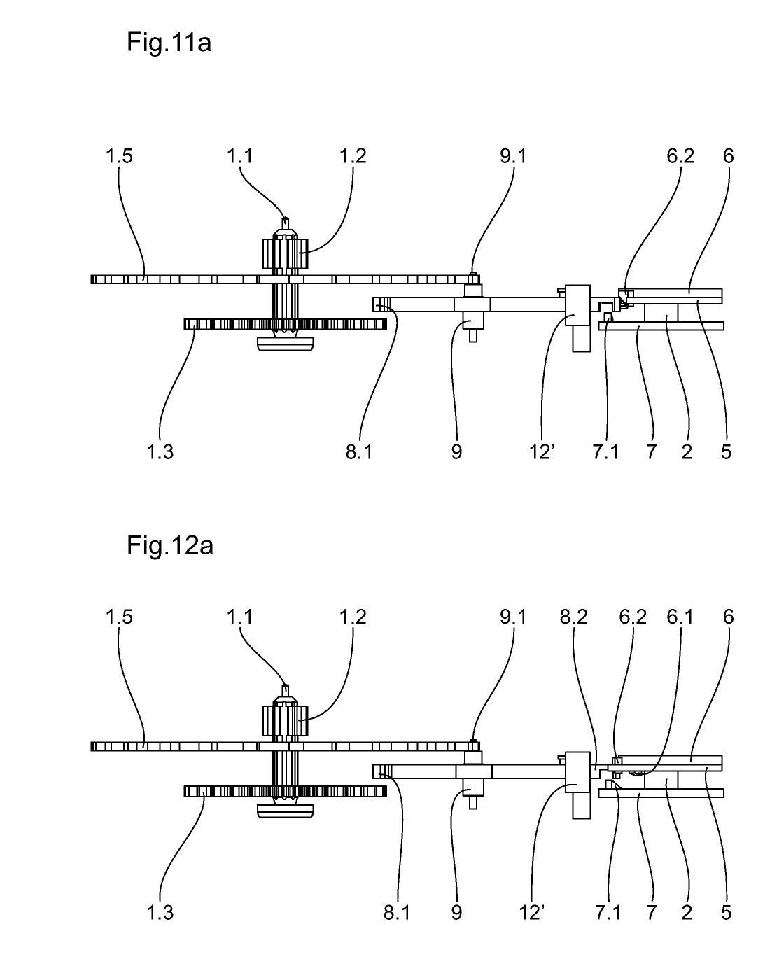

FIGS. 11 and 11 a are plan and side views of the mechanism during the impulse,

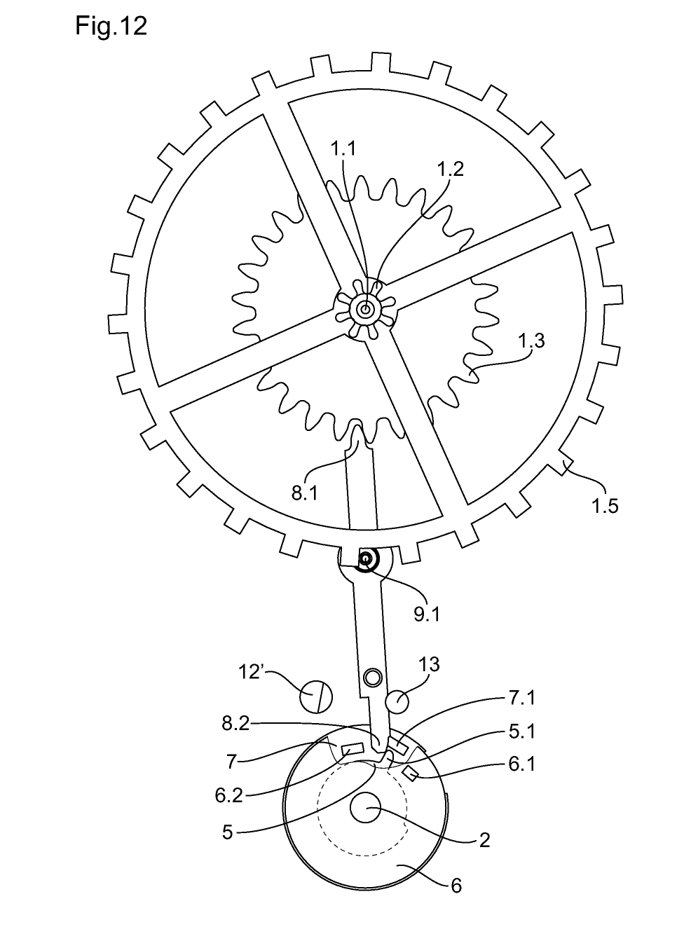

FIGS. 12 and 12a are plan and side views of the mechanism at the end of the rotation of the impulse lever,

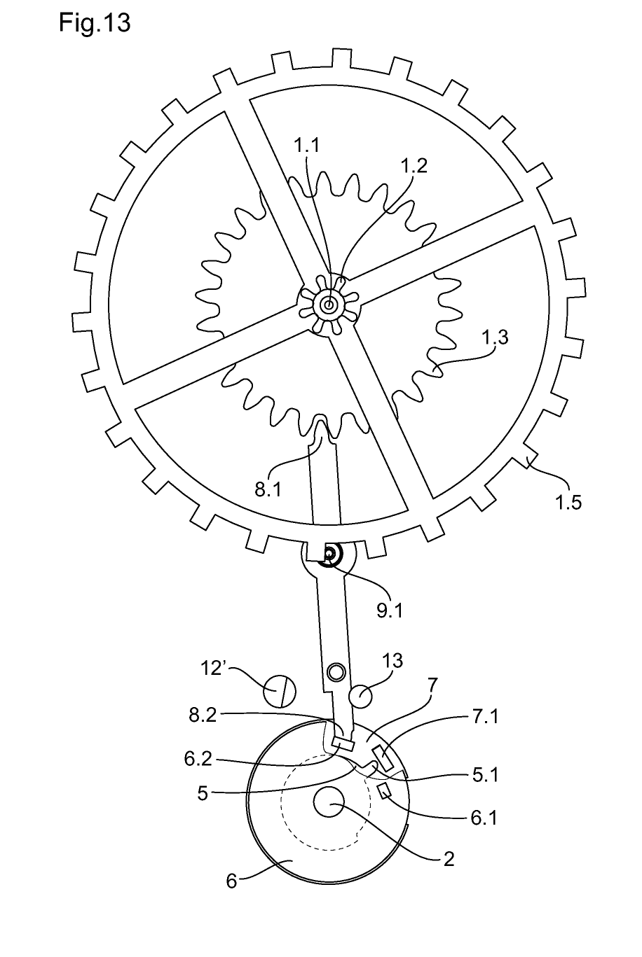

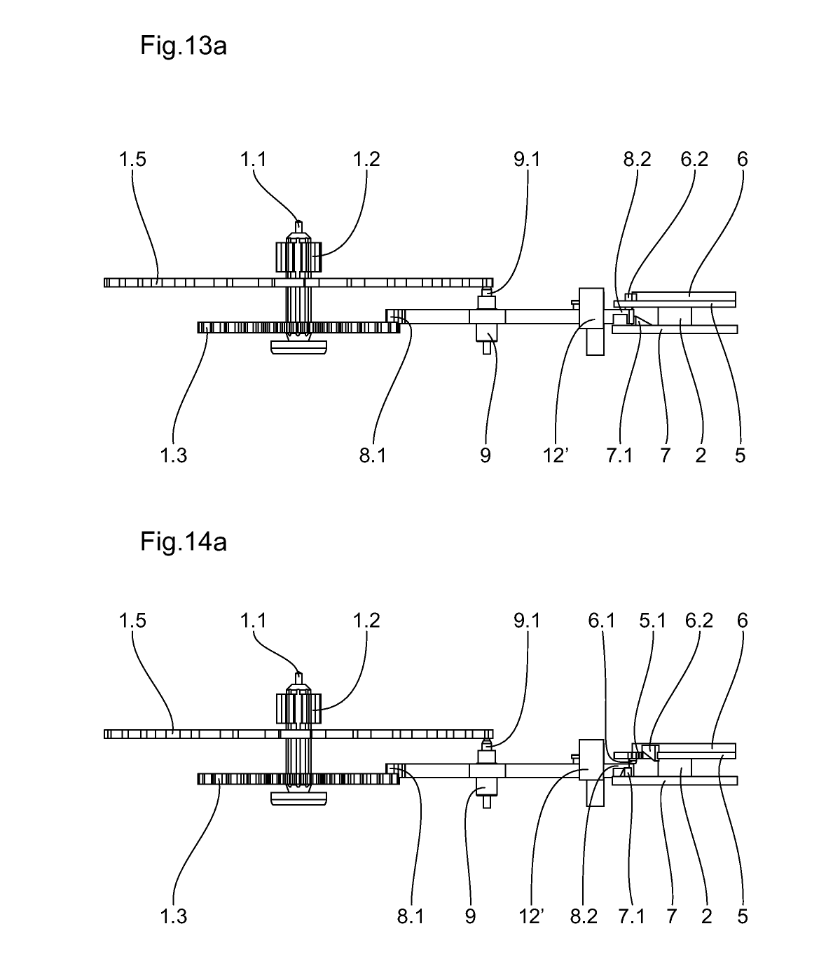

FIGS. 13 and 13a are plan and side views of the mechanism when the impulse lever is engaged with the escapement wheel,

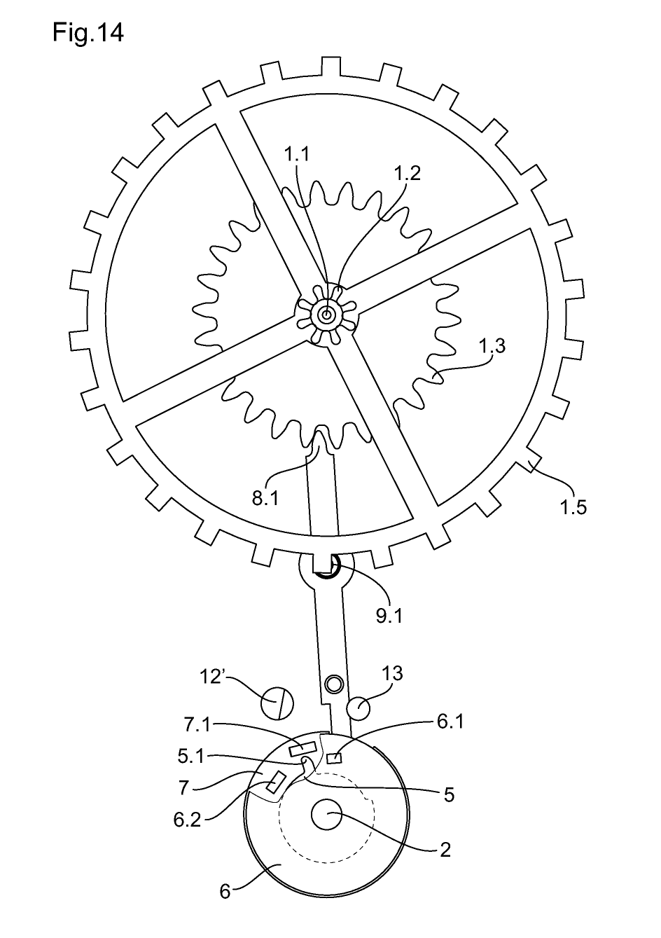

FIGS. 14 and 14a are plan and side views of the mechanism at the end of the first re-winding phase of the impulse lever,

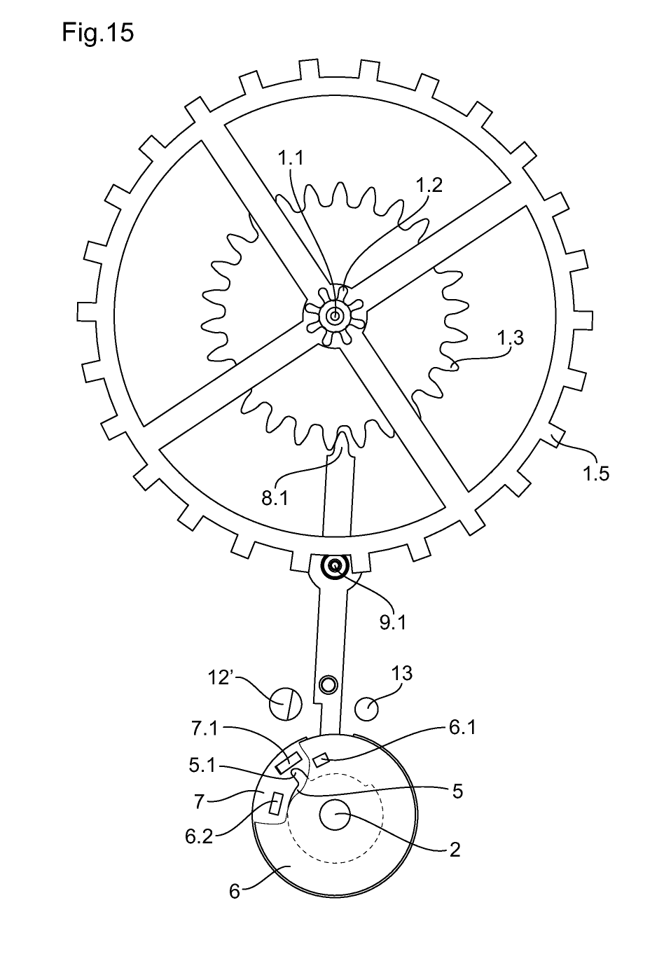

FIGS. 15 and 15a are plan and side views of the mechanism during the second re-winding phase of the impulse lever,

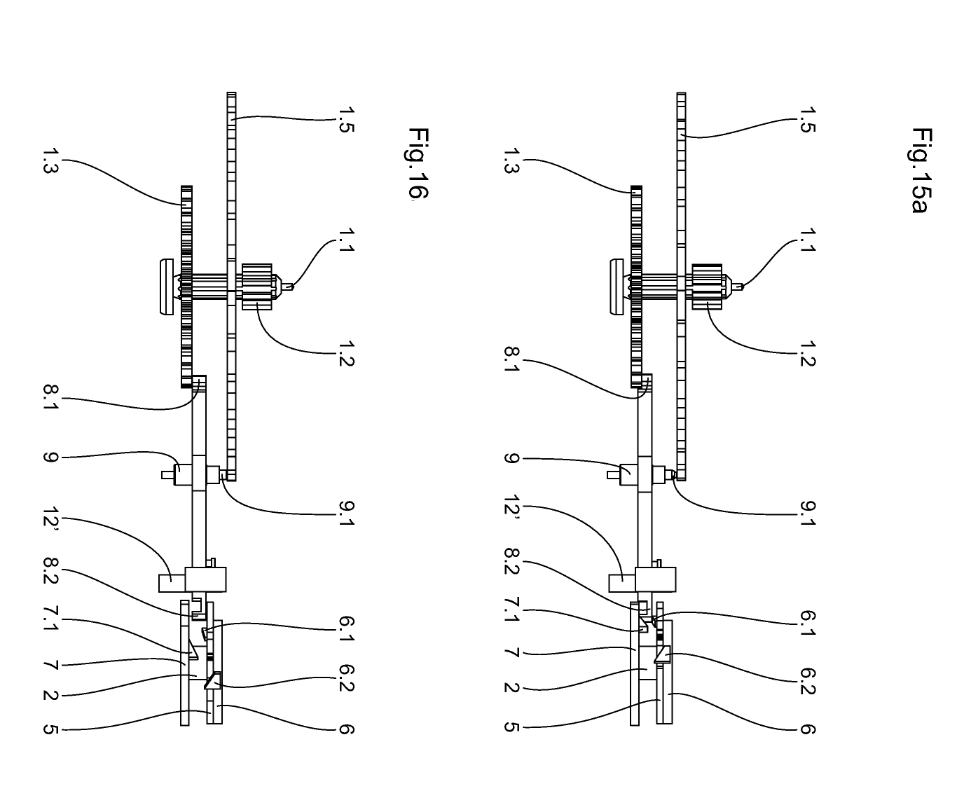

FIG. 16 is a side view of the mechanism during its return to the initial position.

Hereinafter, the orientations and in particular the directions of rotation are provided with reference to the Figures.

A first embodiment of an escapement for a timepiece movement in accordance with the invention will be described with reference to FIGS. 1 to 8.

In accordance with this embodiment, the escapement mechanism is intended to be equipped in a timepiece movement comprising a spring balance and an escapement mobile connected to a barrel by a going train. This escapement mechanism is, in this embodiment, a constant force escapement mechanism and comprises an impulse lever co-operating on the one hand with the escapement mobile and on the other hand with control members fixedly attached to the arbor of the spring balance.

In this first embodiment, the escapement mechanism has an escapement mobile 1 comprising, mounted on an axle 1.1, an escapement pinion 1.2 connected kinematically by a going train (not shown) to the barrel (not shown) of a timepiece movement.

This escapement mobile 1 further comprises a lower escapement wheel 1.3, an intermediate escapement wheel 1.4 and an upper escapement wheel 1.5, all three of which are fixedly attached to the axle 1.1. This escapement mobile 1 is pivoted on a part of the frame of the timepiece movement such as the bottom plate, a bridge or a tourbillon cage of this timepiece movement.

This escapement mechanism further comprises control members fixedly attached to the axle 2 of the spring balance (not shown) pivoted on a part of the frame of the timepiece movement. In this embodiment, this axle 2 of the spring balance has a guard pin safety roller 3 provided with a notch 3.1; a pin safety roller 4 having a pin 4.1 and located beneath the guard pin safety roller 3; an upper control safety roller 6 having an upper cam 6.1 on its lower surface; a lower control safety roller 7 having a lower cam 7.1 on its upper surface facing said upper control safety roller 6; and an impulse safety roller 5 having an impulse finger 5.1 and located between the upper 6 and lower 7 control safety rollers. These different safety rollers and the elements supported thereby or located thereon form a set of control members of the escapement mechanism as explained hereinafter.

The escapement mechanism further comprises an impulse lever 8 mounted so as to be able to pivot and longitudinally slide on a part of the frame of the timepiece movement. The lever 8 is fixedly attached to a lock axle 9 perpendicular to the plane in which the impulse lever 8 pivots. This lock axle 9 preferably extends in parallel with the axle 2 of the spring balance and with the axle of rotation 1.1 of the escapement mobile 1. This lock axle 9 is fixedly attached to a collet 10 which is itself fixedly attached to the inner end of a constant force auxiliary spring 11, preferably a helical spring, whose outer end 11.1 is provided to be fixed on a part of the frame of the timepiece movement.

The impulse lever 8 has a first tooth-shaped end 8.1 intended to co-operate with the teeth of an impulse toothing arrangement of the lower escapement wheel 1.3. This impulse lever 8 has a second end 8.2 extending between the upper control safety roller 6 and the lower control safety roller 7 which are fixedly attached to the axle of the spring balance, which second end is intended to co-operate with the upper 6.1 and lower 7.1 cams. A first pin 12, fixed on a part of the frame of the timepiece movement, is used as a stop for the impulse lever 8. The auxiliary spring 11 tends to displace the impulse lever 8 in the direction of a second pin 13.

The lock axle 9 supporting the impulse lever 8 is able to be displaced longitudinally between a top position in which its locking end 9.1 co-operates with a first locking toothing arrangement of the upper escapement wheel 1.5 and prevents any rotation thereof, and a bottom position in which the upper escapement wheel 1.5 is released from the locking end 9.1 of this lock axle 9.

The escapement mechanism further comprises a locking lever 14 having four arms fixedly attached to a locking lever axle 14.1 pivoted on a part of the frame of the timepiece movement. This locking lever 14 has a first arm 14.2 co-operating with a third pin 15 and a fourth pin 16 for limiting the angular displacement of the locking lever 14.

The locking lever 14 further comprises a second arm 14.3 whose end comprises a fork 14.4 and a guard pin 14.5 intended to co-operate with the pin 4.1 or guard pin safety roller 3 respectively in the manner of a conventional Swiss lever escapement for controlling the angular displacements of the locking lever 14. This locking lever 14 further has a third arm 14.6 whose free end is used as a holding stop for the impulse lever 8 in the wound position against the first pin 12.

Finally, this locking lever 14 has a fourth arm 14.7 whose end has a hook 14.8 intended to co-operate with a second locking toothing arrangement of the intermediate escapement wheel 1.4.

Starting from the initial position of this escapement mechanism in accordance with the first embodiment illustrated in FIGS. 2, 2a, the operation of this mechanism will be described hereinafter. The auxiliary spring 11 is not illustrated in FIGS. 2 to 8 for improved clarity.

In the initial position illustrated in FIGS. 2, 2a, the escapement mobile 1 is locked by the end 9.1 of the lock axle 9 which is in the top position. The impulse lever 8 is also in the top position in which its first end 8.1 is located above the plane of the lower escapement wheel 1.3 and therefore does not co-operate therewith.

The impulse lever 8 is subjected to the action of the torque of the auxiliary spring 11 which tends to rotate it in the clockwise direction (as shown in the Figures). The impulse lever 8 is locked by the end of the third arm 14.6 of the locking lever. The impulse lever 8 subjected to the action of the auxiliary spring 11 pushes the end of the third arm 14.6 of the locking lever 14 which holds it in abutment against the third pin 15 by its second arm 14.2. The guard pin 14.5 and the guard pin safety roller 3 prevent any untimely unlocking of the mechanism.

The balance rotates in the anti-clockwise direction driving the pin 4.1 of the pin safety roller 4 into the fork 14.4 of the locking lever 14 causing the displacement of this locking lever in the clockwise direction until its second arm 14.2 abuts against the fourth pin 16 (FIGS. 3, 4). The impulse lever 8 is released but the escapement mobile 1 is still locked by the lock axle 9.

The released impulse lever 8 is displaced in the clockwise direction under the effect of the auxiliary spring 11. The second end 8.2 of the impulse lever at the level of the impulse safety roller 5 contacts the impulse finger 5.1 and transmits the energy to the balance until the impulse lever 8 reaches the second pin 13. Thus, the energy is transmitted until the impulse lever 8 stops and there is therefore no lost travel on the part of the impulse lever.

The inclined plane of the upper cam 6.1 of the upper safety roller 6 causes the descent of the lever 8 whose first end 8.1 is housed between two teeth of the impulse toothing arrangement of the lower escapement wheel 1.3. During the descent, the impulse lever 8 drives the lock axle 9 until it reaches its bottom position thereby releasing the escapement mobile 1 as soon as the end 9.1 of the lock axle escapes the first locking toothing arrangement of the upper escapement wheel 1.5 (FIG. 5).

In the illustrated embodiment, the collet 10 can move with the axle 9 since the energy of the spring 11 used during the rise/descent of the axle 9 is not significant. In one alternative embodiment, the collet 10 can remain fixed in translation using a sliding link with the axle 9 of the impulse lever 8.

Having been released, the escapement mobile 1 rotates in the anti-clockwise direction, in so doing the impulse toothing arrangement of the lower escapement wheel 1.3 drives the impulse lever 8 in the clockwise direction against the action of the auxiliary spring 11 until the escapement mobile is locked by the hook 14.8 of the fourth arm 14.7 of the locking lever located in the path of the second locking toothing arrangement of the intermediate escapement wheel 1.4 (FIG. 6). The going train and the escapement mobile 1 are thus locked by the locking lever 14 and the intermediate escapement wheel 1.4. The impulse lever 8 is also prevented from rotating by the lower escapement wheel 1.3. The locking lever 14 is held against the pin 15 owing to the force of the intermediate escapement wheel 1.4 on the fourth arm 14.7 of this locking lever 14 (the orientation of the force is considered as in the case of a conventional Swiss lever escapement between the lever and the escapement). The guard pin 14.5 and the guard pin safety roller 3 prevent any untimely unlocking. The balance completes its half-path.

Subsequently, the balance reverses its direction of rotation. The pin 4.1 of the pin safety roller co-operates with the fork of the second arm 14.3 of the locking lever (like in a conventional Swiss lever escapement) which releases the escapement mobile 1, the hook 14.8 of the fourth arm of the locking lever escapes the toothing arrangement of the intermediate escapement wheel 1.4 (FIG. 7).

The thus released escapement mobile 1 resumes its clockwise rotation and the impulse toothing arrangement of the lower escapement wheel 1.3 drives the first end 8.1 of the impulse lever re-winding the auxiliary spring 11 until the impulse lever abuts against the first pin 12 (FIG. 8).

The inclined plane of the lower cam 7.1 of the lower control safety roller 7 causes the impulse lever 8 to rise again, disengaging it from the lower escapement wheel 1.3. In so doing, the lock axle 9 is also raised and its locking end 9.1 is housed between two teeth of the locking toothing arrangement of the upper escapement wheel 1.5 locking the escapement mobile 1 and the going train (FIG. 8). The end of the third arm 14.6 of the locking lever 14 locks the impulse lever 8 and the mechanism is back in its initial position (FIG. 2).

In this first illustrated embodiment, the escapement mobile 1 has three escapement wheels 1.3, 1.4 and 1.5 each having a toothing arrangement.

The impulse toothing arrangement is supported by the lower escapement wheel 1.3 and co-operates with the impulse lever 8, the second locking toothing arrangement is supported by the intermediate escapement wheel 1.4 and co-operates with the fourth arm 14.7 of the locking lever 14 and the first locking toothing arrangement is supported by the upper escapement wheel 1.5 and co-operates with the lock axle 9. The number of escapement wheels can be reduced so long as the escapement mobile 1 has the three toothing arrangements co-operating with the impulse lever 8, the locking lever 14 and the lock axle 9 respectively. These three toothing arrangements can in fact be supported by only one or two wheels.

A second embodiment will now be described with reference to FIGS. 9 to 16 in which the same reference numerals designate the same elements as in the first embodiment.

The escapement mechanism in accordance with this second embodiment of the invention is also intended to be equipped in a timepiece movement comprising a spring balance and an escapement mobile connected to a barrel by a going train.

In this second embodiment illustrated by way of example in FIGS. 9 to 16, the escapement mechanism is a constant force escapement and has an escapement mobile 1 comprising, mounted on an axle 1.1, an escapement pinion 1.2 connected kinematically by a going train (not shown) to the barrel (not shown) of a timepiece movement.

In contrast to the first embodiment, the escapement mechanism in accordance with this second embodiment does not comprise a locking lever and the escapement mobile 1 only comprises two wheels, namely a lower escapement wheel 1.3 and an upper escapement wheel 1.5, both of which are fixedly attached to the axle 1.1. This escapement mobile 1 is pivoted on a part of the frame of the timepiece movement such as the bottom plate or a bridge of this timepiece movement.

This escapement mechanism further comprises control members fixedly attached to the axle 2 of the spring balance (not shown) pivoted on a part of the frame of the timepiece movement. In this second embodiment, this axle 2 of the spring balance has an impulse safety roller 5 having an impulse finger 5.1 and located between an upper control safety roller 6 having a first upper cam 6.1 and a second upper cam 6.2 on its lower surface, and a lower control safety roller 7 having a lower cam 7.1 on its upper surface facing said upper control safety roller 6. These different safety rollers and the elements supported thereby or located thereon form, once again, a set of control members of the escapement mechanism as explained hereinafter.

In accordance with this embodiment, the escapement mechanism further comprises an impulse lever 8 mounted so as to be able to pivot and longitudinally slide on a part of the frame of the timepiece movement. The lever 8 is fixedly attached to a lock axle 9 perpendicular to the plane in which the lever pivots. This lock axle 9 preferably extends in parallel with the axle 2 of the spring balance and with the axle of rotation 1.1 of the escapement mobile 1. Like in the first embodiment, this lock axle 9 is preferably fixedly attached to a collet which is itself fixedly attached to the inner end of a constant force auxiliary helical spring (not illustrated in the Figures for improved clarity), whose outer end is provided to be fixed on a part of the frame of the movement.

The impulse lever 8 has a first tooth-shaped end 8.1 intended to co-operate with the teeth of an impulse toothing arrangement of the lower escapement wheel 1.3. This impulse lever 8 has a second end 8.2 extending between the upper control safety roller 6 and the lower control safety roller 7 which are fixedly attached to the axle of the spring balance, which second end is intended to co-operate with the first and second upper cams 6.1, 6.2 and the lower cam 7.1. A first pin 12′, fixed on a part of the frame of the timepiece movement, is used as a stop for locking the impulse lever 8. In this embodiment, the auxiliary spring 11 tends to displace the impulse lever 8 in the direction of a second pin 13.

The lock axle 9 supporting the impulse lever 8 is able to be displaced longitudinally between a top position in which its locking end 9.1 co-operates with a first locking toothing arrangement of the upper escapement wheel 1.5 and prevents any rotation thereof, and a bottom position in which the upper escapement wheel 1.5 is released from the locking end 9.1 of this lock axle 9.

Starting from the initial position of this escapement mechanism in accordance with the second embodiment illustrated in FIGS. 9, 9a, the operation of this mechanism will be described hereinafter.

In the initial position illustrated in FIGS. 9, 9a, the escapement mobile 1 is locked by the end 9.1 of the lock axle 9. The impulse lever 8 is in a first intermediate position in which its first end 8.1 is located above the plane of the lower escapement wheel 1.3 and therefore does not co-operate therewith and in which its second end 8.2 co-operates with the first pin 12′ preventing the impulse lever from rotating in the anti-clockwise direction (in accordance with the Figures) in the direction of the pin 13.

The impulse lever 8 is subjected to the action of the torque of the auxiliary spring 11 which tends to rotate it in the anti-clockwise direction in the direction of the pin 13. In the initial position, the impulse lever 8 is held in abutment against the first pin 12′ under the action of the auxiliary spring 11. The balance rotates in the clockwise direction driving the lower cam 7.1 of the lower control safety roller 7 in contact with the second end 8.2 of the impulse lever 8. The inclined plane of said lower cam 7.1 causes the displacement of this impulse lever 8 towards the top. Said impulse lever 8 is thus in its top position and is no longer held by the first pin 12′ (FIGS. 10, 10a). The impulse lever 8 is released but the escapement mobile 1 is still locked by the lock axle 9 which is also in its top position.

The released impulse lever 8 is displaced in the anti-clockwise direction under the effect of the auxiliary spring 11. The second end 8.2 of the impulse lever at the level of the impulse safety roller 5 contacts the impulse finger 5.1 (FIGS. 11, 11a) and transmits the energy to the balance until the impulse lever 8 reaches the second pin 13. Thus, the energy is transmitted until the impulse lever 8 stops and there is therefore no lost travel on the part of the impulse lever (FIGS. 12, 12a).

The inclined plane of the first upper cam 6.1 of the upper safety roller 6 causes the descent of the lever 8 from its top position into a second intermediate position, the first end 8.1 of said impulse lever 8 being housed between two teeth of the impulse toothing arrangement of the lower escapement wheel 1.3. During the descent, the impulse lever 8 drives the lock axle 9 until it reaches an intermediate position in which said lock axle 9 still locks the escapement mobile. The impulse lever 8 is still locked by the second pin 13 (FIGS. 13, 13a).

The balance reverses its direction of rotation. The inclined plane of the second upper cam 6.2 of the upper safety roller 6 causes the descent of the lever 8 from its second intermediate position into its low position, with the first end 8.1 of said impulse lever 8 remaining housed between two teeth of the impulse toothing arrangement of the lower escapement wheel 1.3. During the descent, the impulse lever 8 drives the lock axle 9 until it reaches its low position, releasing the escapement mobile 1 once the end 9.1 of the lock axle escapes the first locking toothing arrangement of the upper escapement wheel 1.5 (FIGS. 14, 14a).

The thus released escapement mobile 1 resumes its rotation in the anti-clockwise direction (in accordance with the Figures) and the impulse toothing arrangement of the lower escapement wheel 1.3 drives the first end 8.1 of the impulse lever in the clockwise direction re-winding the auxiliary spring 11 until the impulse lever abuts against the first pin 12′ (FIGS. 15, 15a). This first pin 12′ is chamfered and has an inclined plane which, under the force of the impulse lever 8 pushed against said pin 12′ by the escapement mobile 1, causes the rise of said impulse lever 8 into its first intermediate position (initial position). In so doing, the first end 8.1 of the impulse lever 8 is disengaged from the lower escapement wheel 1.3. The lock axle 9 is also raised into its initial position and its locking end 9.1 is housed between two teeth of the locking toothing arrangement of the upper escapement wheel 1.5 locking the escapement mobile 1 and the going train. The mechanism is back in its initial position (FIGS. 9, 9a).

As shown above, in this embodiment, the escapement mobile 1 comprises two escapement wheels 1.3 and 1.5 each having a toothing arrangement. The impulse toothing arrangement is supported on the lower escapement wheel 1.3 and co-operates with the impulse lever 8, and the first locking toothing arrangement is supported on the upper escapement wheel 1.5 and co-operates with the lock axle 9. The number of escapement wheels can be reduced so long as the escapement mobile 1 comprises the two toothing arrangements co-operating with the impulse lever 8 and the lock axle 9 respectively. These two toothing arrangements can, in fact, be supported on a single wheel.

This escapement mechanism in accordance with the invention has the feature of having separated the function of locking the escapement mobile 1 which is effected either by the lock axle 9 and the fourth arm 14.7 of the locking lever in the first embodiment or by merely the lock axle 9 in the second embodiment, and the impulse function which is effected using the impulse lever 8 and the auxiliary spring 11. In particular, these two functions are effected, at least partly, in different planes forming an angle therebetween: in the illustrated embodiments the impulse takes place in a plane substantially perpendicular to the balance axle whilst the regulating or locking takes place, at least partly, in a plane comprising the axle of the escapement mobile.

It will be noted in particular that during the impulse phase the escapement mobile 1 and thus the entire going train of the movement is locked such that the inertia of the moving parts during an impulse is very low, thus preventing any recoil of the escapement mobile 1. Moreover, all of the angular travel of the impulse lever is effectively active without any lost travel. Owing to these arrangements, the performance of the escapement mechanism is greatly improved, as is the precision of the chronometry of the movement provided with this escapement mechanism. Finally, in the described embodiments, the energy transmitted to the balance at each impulse is strictly constant since it depends only upon the auxiliary spring which re-winds between each impulse.

In the illustrated embodiments, the regulating member formed by the lock axle 9 is fixedly attached to the impulse lever 8 and is used as its pivot axle. In alternative embodiments, the regulating member could be independent of the impulse lever 8 and controlled by another pair of cams supported by lower 7 and upper 6 control safety rollers which are fixed to the axle 2 of the balance.

1. Timepiece movement comprising an escapement mobile connected to a barrel by a going train and a spring balance as well as an escapement mechanism (1) comprising an impulse lever (8) and at least one regulating member (9);
characterised in that the impulse lever (8) and the regulating member (9) are controlled by control members (6.1, 6.2, 7.1) supported on the axle of the balance;
in that the impulse lever (8) and the regulating member (9) co-operate with the escapement mobile (1); and in that between positions in which they co-operate with the escapement mobile (1) and positions in which they do not co-operate with the escapement mobile, the impulse lever (8) and the regulating member (9) move in two different planes forming an angle therebetween.

2. Timepiece movement as claimed in claim 1, characterised in that the escapement mechanism (1) is a constant force escapement mechanism comprising an auxiliary spring (11), one end of which is fixedly attached to the impulse lever (8).

3. Timepiece movement as claimed in claim 2, characterised in that the auxiliary spring (11) is a helical spring, and in that the inner end of this helical spring is fixed to a collet of the impulse lever (8) whilst its outer end is fixed on a part of the frame of the timepiece movement.

4. Timepiece movement as claimed in claim 1, characterised in that the impulse lever (8) moves in a first plane which is substantially perpendicular to the axle of the balance.

5. Timepiece movement as claimed in claim 4, characterised in that the displacement of the impulse lever (8) is a rotation about a first axle perpendicular to the first plane.

6. Timepiece movement as claimed in claim 1, characterised in that the regulating member (9) moves in a second plane which is substantially in parallel with the axle of the escapement mobile (1).

7. Timepiece movement as claimed in claim 6, characterised in that the displacement of said regulating member (9) is a linear translation in the second plane.

8. Timepiece movement as claimed in claim 4, characterised in that it comprises a second regulating member (14) which, between a position in which it co-operates with the escapement mobile (1) and a position in which it does not co-operate with the escapement mobile, moves in rotation about a second axle perpendicular to the first plane.

9. Timepiece movement as claimed in claim 1, characterised in that a first end (8.1) of the impulse lever (8) co-operates with a first toothing arrangement of the escapement mobile (1), and in that a second end (8.2) of the impulse lever (8) co-operates with two cams (6.1, 7.1) respectively supported by upper (6) and lower (7) control safety rollers of the axle (2) of the balance.

10. Timepiece movement as claimed in claim 9, characterised in that the axle (2) of the balance supports an impulse safety roller (5) located between the lower (7) and upper (6) control safety rollers of this axle (2); in that this impulse safety roller (5) has an impulse finger (5.1) intended to co-operate in the impulse phases with the second end (8.2) of the impulse lever extending between upper (6) and lower (7) control safety rollers.

11. Timepiece movement as claimed in claim 10, characterised in that it comprises two pins (12, 13) fixed on a part of the frame of the timepiece movement delimiting the end angular positions of the impulse lever (8).

12. Timepiece movement as claimed in claim 1, characterised in that the impulse lever (8) is fixedly attached to a lock axle (9), one end (9.1) of which co-operates with a locking toothing arrangement of the escapement mobile (1).

13. Timepiece movement as claimed in claim 12, characterised in that it further comprises a locking lever (14) pivoted on a part of the frame of the timepiece movement and having a first arm (14.2) co-operating with third and fourth pins (15, 16) fixed on a part of the frame of the movement and defining the end angular positions of the locking lever, and a second arm (14.3) whose end is provided with a fork (14.4) and a guard pin (14.5) co-operating respectively with a pin (4.1) fixedly attached to the axle (2) of the balance and a guard pin safety roller (3) also supported on the axle (2) of the balance.

14. Timepiece movement as claimed in claim 13, characterised in that the locking lever (14) has a third arm (14.6) intended to hold the impulse lever (8) in the wound position against the first pin (12, 12′) during the operating phase of the mechanism where the impulse lever is stationary.

15. Timepiece movement as claimed in claim 14, characterised in that the locking lever (14) has a fourth arm (14.7) whose end supports a hook (14.8) intended to co-operate with a second locking toothing arrangement of the escapement mobile (1).

16. Timepiece movement as claimed in claim 9, characterised in that each of the toothing arrangements of the escapement mobile (1) is supported on a wheel (1.3, 1.4, 1.5) of this escapement mobile (1).

17. A timepiece comprising a movement according to claim 1.
